(19) United States
(12) Patent Application Publication
(10) Pub. No.: US 2021/0382309 A1
(43) Pub. Date: Dec. 9, 2021

(54) IMAGE DISPLAY DEVICE

(71) Applicant: Hitachi-LG Data Storage, Inc., Tokyo (JP)

(72) Inventors: Takeru UTSUGI, Tokyo (JP); Tomoto KAWAMURA, Tokyo (JP)

(21) Appl. No.: 17/327,874

(22) Filed: May 24, 2021

(30) Foreign Application Priority Data
Jun. 3, 2020 (JP) 2020-097147

(51) Int. Cl. G02B 27/01

(52) U.S. Cl. CPC G02B 27/0172; G02B 2027/0125; G02B 2027/0178

(57) ABSTRACT

An objective of the present disclosure is to provide an image display device capable of (1) improving light utilization efficiency in a waveguide direction, and (2) overcoming a trade-off relationship between FoV and an eye-box in a non-waveguide direction. In the image display device according to the present disclosure, the waveguide includes a first angle conversion region for angular conversion of first image light, and a second angle conversion region for angular conversion of second image light in a direction different from the first image light.

### CROSS-REFERENCE TO RELATED APPLICATION

This application claims the priority of Japanese Patent Application No. 2020-097147 filed Jun. 3, 2020, which is incorporated herein by reference in its entirety.

### BACKGROUND OF THE DISCLOSURE

### 1. Field of the Disclosure

The present disclosure relates to an image display device for projecting image light by a virtual image.

### 2. Description of the Related Art

An image display device such as a head mounted display (HMD) uses a waveguide as an optical system for propagating the image light emitted from the projector (image projector) to the user's eyes. It is desirable that the waveguide used by HMDs is thin and has a wide field of view (FoV) in which images can be seen. In addition, it is also required to have a wide area (eye-box) in which images can be visually recognized.

WO2016/020643A1 discloses a method of using SRG (Surface Relief Grating) in a waveguide of HMD. In this document, by expanding the incident light two-dimensionally (referred to as two-dimensional expansion) using three diffraction gratings, it is possible to achieve both a wide FoV and a wide eye-box. However, in the two-dimensional expansion using a diffraction grating as in the method of this document, the light is diffracted also toward outside of the eye-box. Thus, the light utilization efficiency is extremely poor.

WO2017/176393A1 discloses a method of using a skew mirror in the waveguide of the HMD. In this document, a skew mirror is used implemented by volume-type hologram structure in which a reflection diffraction surface is inclined with respect to the waveguide surface, thereby expanding the incident light one-dimensionally (referred to as one-dimensional expansion) to realize a high light utilization efficiency. However, it is difficult to achieve both a wide FoV and a wide eye-box by one-dimensional expansion as in the method of this document.

### SUMMARY OF THE DISCLOSURE

As described above, it has so far been difficult to realize both a wide FoV and a wide eye-box while maintaining a high light utilization efficiency. There are two reasons for this difficulty: (1) the light utilization efficiency is decreased in the waveguide direction, (2) the non-waveguide direction has a trade-off relationship between FoV and eye-box. The waveguide direction is an eye-box expanding direction in the waveguide plane. The non-waveguide direction is a direction perpendicular to the waveguide direction in the one-dimensional expansion.

In WO2016/020643A1, since the waveguide direction is set two-dimensionally by two-dimensional expansion, the light utilization efficiency is remarkably lowered due to the reason (1) above. In WO2017/176393A1, since one-dimensional expansion is employed, a trade-off relationship occurs between the FoV and the eye-box due to the reason (2) above in the non-waveguide direction in which the expansion is not performed.

The present disclosure has been made in view of the problems above, and an objective of the present disclosure is to provide an image display device capable of (1) improving light utilization efficiency in a waveguide direction, and (2) overcoming a trade-off relationship between FoV and an eye-box in a non-waveguide direction.

In the image display device according to the present disclosure, the waveguide includes a first angle conversion region for angular conversion of first image light, and a second angle conversion region for angular conversion of second image light in a direction different from the first image light.

With the image display device according to the present disclosure, in the waveguide of one-dimensional expansion scheme with high light utilization efficiency, it is possible to achieve both wide FoV and wide eye-box.

### BRIEF DESCRIPTION OF THE DRAWINGS

FIG. 1A illustrates an external view of a HMD 100 according to an embodiment 1.

FIG. 1B illustrates components of the HMD 100.

FIG. 2A illustrates a block diagram of the HMD 100.

FIG. 2B illustrates a configuration of an image inputting unit 101.

FIG. 3A illustrates a configuration of a conventional waveguide 200 employing one-dimensional expansion scheme.

FIG. 3B illustrates a grating vector diagram of a principal ray for indicating an angle conversion function of the light beam in an emitting coupler unit 310.

FIG. 4A is a cross-sectional view in which a waveguide direction of the waveguide 200 can be easily viewed.

FIG. 4B is a schematic diagram illustrating a non-waveguide direction.

FIG. 5 is a schematic diagram illustrating a light beam from the pupil plane P to the user 1.

FIG. 6 illustrates a case where the user is at a position where the distance between the pupil plane P and the eye of the user 1 is E (E<C).

FIG. 7A illustrates a configuration of a waveguide according to an embodiment 1.

FIG. 7B is a grating vector in an upper emitting coupler unit 710.

FIG. 7C is a grating vector in a lower emitting coupler unit 700.

FIG. 8 is a conceptual diagram showing a configuration of a non-waveguide direction.

FIG. 9A illustrates an innermost light beam emitted from the projector.

FIG. 9B illustrates a center light beam emitted from the projector.

FIG. 9C illustrates an outermost light beam emitted from the projector.

FIG. 10A is a schematic diagram illustrating a configuration in which a region 1000 where the ray regions of the projector for projecting upper and lower images overlap with each other.

FIG. 10B is a schematic diagram illustrating a configuration in which a region 1000 where the ray regions of the projector for projecting upper and lower images overlap with each other.

FIG. 10C is a schematic diagram illustrating a configuration in which a region 1000 where the ray regions of the projector for projecting upper and lower images overlap with each other.

FIG. 11 illustrates a specific configuration of a waveguide that realizes superimposing emitted light beams as shown in FIG. 10A to FIG. 10C.

FIG. 12 illustrates a configuration example of the image outputting unit for generating upper image light 720 and lower image light 730.

FIG. 13 illustrates another configuration example of the image outputting unit.

### DESCRIPTION OF THE PREFERRED EMBODIMENTS

### Embodiment 1

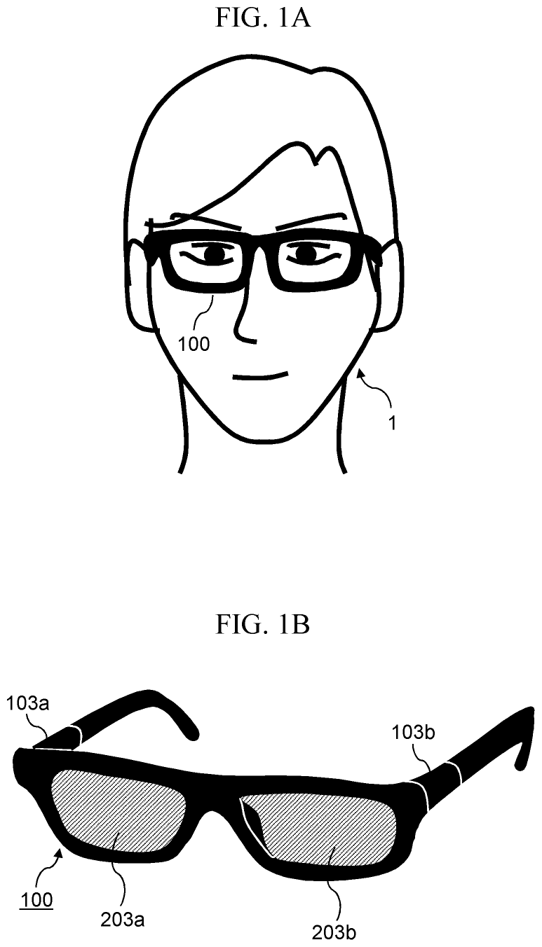

FIG. 1A illustrates an external view of a HMD 100 according to an embodiment 1 of the present disclosure. A user 1 is wearing the HMD 100. The HMD 100 is of glasses type. The user 1 can view not only the outside world via the HMD 100 but also view the image light from the image display device at the same time. As a result, the HMD 100 realizes an augmented reality (AR).

FIG. 1B illustrates components of the HMD 100. An image display device is mounted on temple portions 103a and 100b of the eyeglasses. An image is sent from the image display device to the waveguides 203a and 203b, and the user 1 can visually recognize the image. The waveguide is highly transparent and thin. The waveguide is realized by SRG, volume type hologram, beam splitter array, etc.

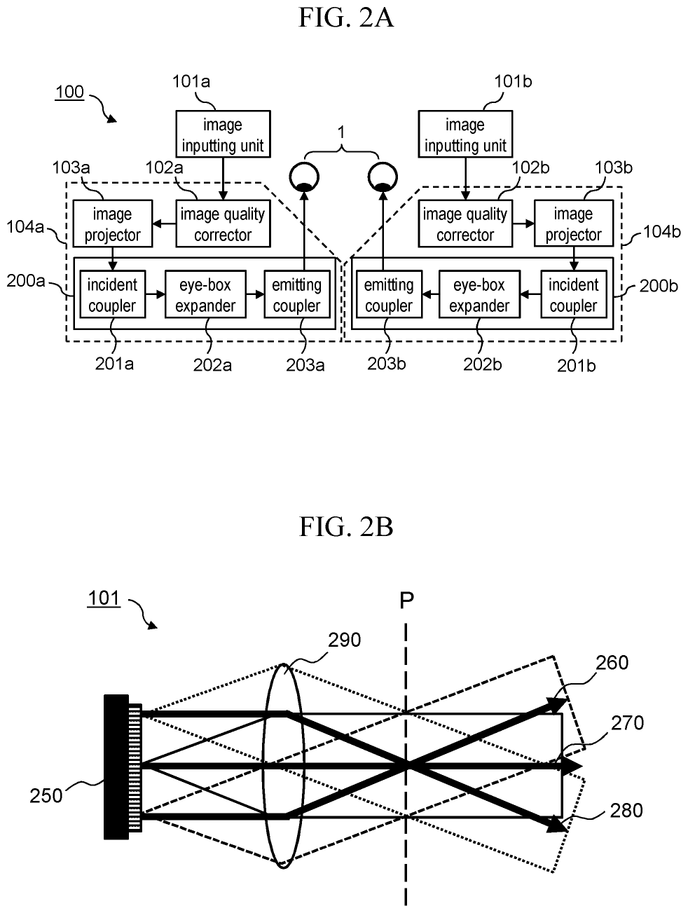

FIG. 2A illustrates a block diagram of the HMD 100. The HMD 100 includes a right eye image display unit 104a for displaying an image on the right eye of the user, and a left eye image display unit 104b for displaying an image on the left eye of the user. Since the two image display units have the same configuration for both of the right eye and for the left eye, the suffixes a and b will be omitted below except when distinguishing between the right eye (indicated by the suffix a) and the left eye (indicated by the suffix b). In FIG. 2A, the suffixes a and b are attached to the other components for the right eye and the left eye, respectively. The suffixes a and b are omitted when the components for the right eye and the left eye are not distinguished from each other.

The image display unit 104 generates an image to be displayed by the image quality corrector 102 and the image projector 103 in accordance with the image data sent from the image inputting unit 101. The image quality corrector 102 corrects the color and luminance of the displayed image. Specifically, the image is adjusted so that color irregularity, luminance irregularity, color misalignment, and the like are minimized. The image projector 103 is configured using a small projector including a light source, and has an optical system for projecting a virtual image of the image. In other words, when looking directly into the image projector 103, it is possible to view a two-dimensional image at a position of a certain distance. The distance onto which the image (virtual image) is projected may be a certain finite distance, or may be infinity. However, in order to suppress shaking images due to shifts in image display position when viewing the image along with changing the position of the light guide, it is desirable that the distance is infinity in the embodiment 1.

The image generated by the image projector 103 is emitted as a group of light beams so as to project a virtual image at a certain distance. This light beam group has a wavelength corresponding to at least three colors of red (R), green (G) and blue (B), and the user can view the color image.

The light beam group emitted from the image projector 103 is incident on the waveguide 200 via the incident coupler 201. The incident coupler 201 converts the direction of the light beam group incident on the waveguide 200 into a direction that can be propagated within the waveguide 200 in accordance with total reflection. At this time, a high-definition image without distortion or blurring of the image can be displayed by performing the conversion as well as keeping the relative relationship between each beam direction of the beam group.

The light beam group incident on the waveguide 200 propagates inside the waveguide 200 by repeating the total reflection, and enters the eye-box expander 202. The eye-box expander 202 has a function of expanding an eye-box in which a user can view an image (i.e. a region where the user can visually recognize the virtual image). If the eye-box is wide, the user is less likely to see the edge portion of the eye-box, so that the user's stress is reduced. In addition, influence of individual differences in the wearing condition or the position of the user's eyes is reduced, thereby obtaining a highly realistic feeling.

The eye-box expander 202 duplicates the incident beam group while keeping the relative relationship in the beam direction, and emits the beam group toward the emitting coupler 203. In other words, the light beam group emitted from the image projector 103 is spatially expanded while maintaining the relative relationship in the light beam direction (angle).

The emitting coupler 203 emits the incident light beam group to the outside of the waveguide 200 to reach the user's first eye. In other words, opposite to the incident coupler 201, the emitting coupler 203 converts the direction of the incident beam group into a direction that can be emitted to outside of the waveguide 200.

The configuration above is approximately common for both of the right eye image display unit 104a and the left eye image display unit 104b. With the above-described configuration, the user 1 can see the image (virtual image) displayed by the two image display units 104a and 104b.

In the HMD 100 of FIG. 1A, only the emitting coupler 203 as a part of the waveguide 200 is visible. The other portions of the waveguide 200 are hidden in the black frame portion so as not to be visible from outside. This is because when the light of the outside world (external light) from an unintentional angle is incident on the waveguide 200, there arises a possibility that the incident light becomes stray light which degrades the image quality of the displayed image. Therefore, the portions other than the emitting coupler 203 are made not visible from the outside as much as possible, so that the external light does not enter the waveguide 200.

FIG. 2B illustrates a configuration of the image inputting unit 101. An image projected at infinity is inputted to the image inputting unit 101. As shown in FIG. 2B, by projecting the image light emitted from the image generator 250 to infinity by the lens 290, the image is projected. This can be implemented by placing the image generator 250 on the front focal plane of the lens 290. The image generator 250 is a combination of a two-dimensional spatial light modulator (DMD (Digital Mirror Device) or LCOS (Liquid Crystal On Silicon)) and a light source, or a self-emitting device such as a OLED (Organic Light Emitting Diode) or a micro-LED (Light Emitting Diode). The back focal plane of the lens 290 is referred to as a pupil plane P. The pupil plane P is a place where the principal ray (260, 270, 280) of each image light corresponding to each pixel of the image generator 250 intersects at one point. All of the image light corresponding to one pixel has a beam diameter of approximately 2 to 10 millimeters.

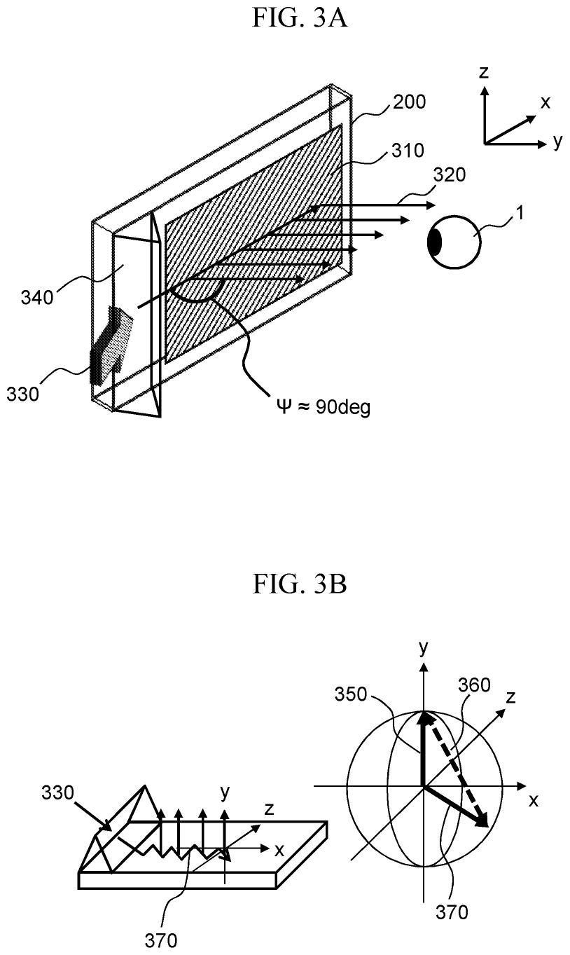

FIG. 3A illustrates a configuration of a conventional waveguide 200 employing one-dimensional expansion scheme. This configuration is referred to as side injection. This configuration enters the image light 330 from the portion of the eyeglasses' temple (both sides) to the waveguide. The image light 330 is incident on the waveguide 200 by the incident coupler unit 340, is guided within the waveguide 200 by total reflection, is emitted by the emitting coupler unit 310 to the outside, and then reaches the user 1. The angle ψ in the figure is approximately 90 degrees. The direction in which the light propagates in the waveguide 200 by total reflection is the x direction of the figure. The emission direction of the light is the y direction. The x direction is referred to as the waveguide direction, and the z direction is referred to as the non-waveguide direction.

FIG. 3B illustrates a grating vector diagram of a principal ray for indicating an angle conversion function of the light beam in an emitting coupler unit 310. The angular transformation is made in the XY plane. The light guided in the X direction (beam vector 370) propagates in the X direction while reflecting back by total reflection in the XY plane. The angular transformation of the beam is performed by the grating vector 360 so as to cause the beam vector 370 to exit in the Y direction (beam vector 350). When the sum of the incident light vector and the grating vector coincides on the same spherical surface, this sum vector becomes the emitted light vector. The emitting coupler unit 310 is formed by a diffractive optical element such as a volume type hologram, a beam splitter array, or SRG having the function of converting the light beam angle. In the following configuration, an example will be described using a volume type hologram having high transparency and high efficiency.

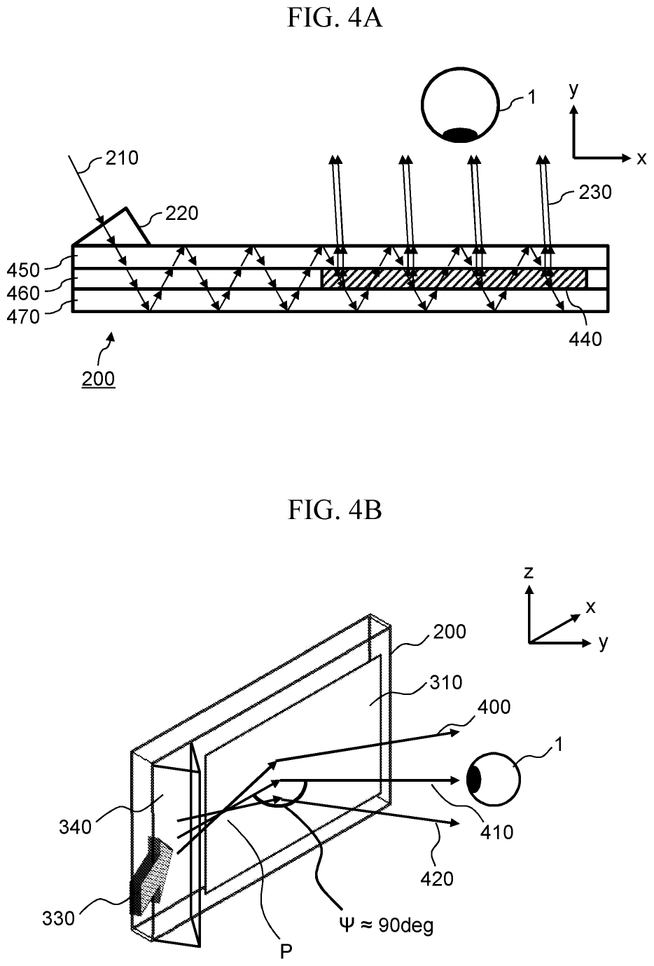

FIG. 4A is a cross-sectional view in which a waveguide direction of the waveguide 200 can be easily viewed. The waveguide 200 is formed by a transmission type incident prism 220 serving as an incident coupler, and a hologram portion 240 serving as an eye-box expander and an emitting coupler. These are housed in a synthetic resin substrate such as glass or plastic. The thickness is about 1 to 2 millimeters. For example, these components have a three-layer structure including a cover layer 450, a medium layer 460, and a cover layer 470.

The light beam group emitted from the image projector 103 (only the central beam 210 is shown) has a wide wavelength range corresponding to the RGB light and a wide angle range corresponding to FoV. The light beam group is incident on the incident prism 220. FIG. 4A shows the path in the waveguide 200 for the central beam 210 (hereinafter, referred to as incident light as a representative of the beam group) in the light beam group. The incident light 210 corresponds to a pixel of substantially the center of the image to be displayed. The incident light 210 actually is a luminous flux having a finite thickness with a diameter of several millimeters.

The hologram unit 240 is formed by a volume-type hologram configured as a light diffraction unit. The hologram unit 240 converts the direction of the light beam group incident as described above, and emits the light beam group to the outside of the waveguide 200. Since the volume type hologram diffracts a portion of the guided light, the remaining light is guided without diffracted. By repeating this operation, a large number of outgoing beam groups 230 are copied in the plane and then are emitted. As a result, the eye-box is expanded in the X direction.

FIG. 4B is a schematic diagram illustrating the non-waveguide direction. The non-waveguide direction is the z-direction in FIG. 4B. In this direction, the light beam intersects at the pupil plane P and then spreads out. The pupil plane P is located in the waveguide 200 in FIG. 4B. Since the light is emitted to the outside by the emitting coupler unit 310, the direction of the light beam is bent from the x direction into the y direction. However, in terms of the light beam in the z direction (non-waveguide direction), such bending of the light may be ignored. Therefore, a simplified diagram will be shown below in which the bent portion is omitted.

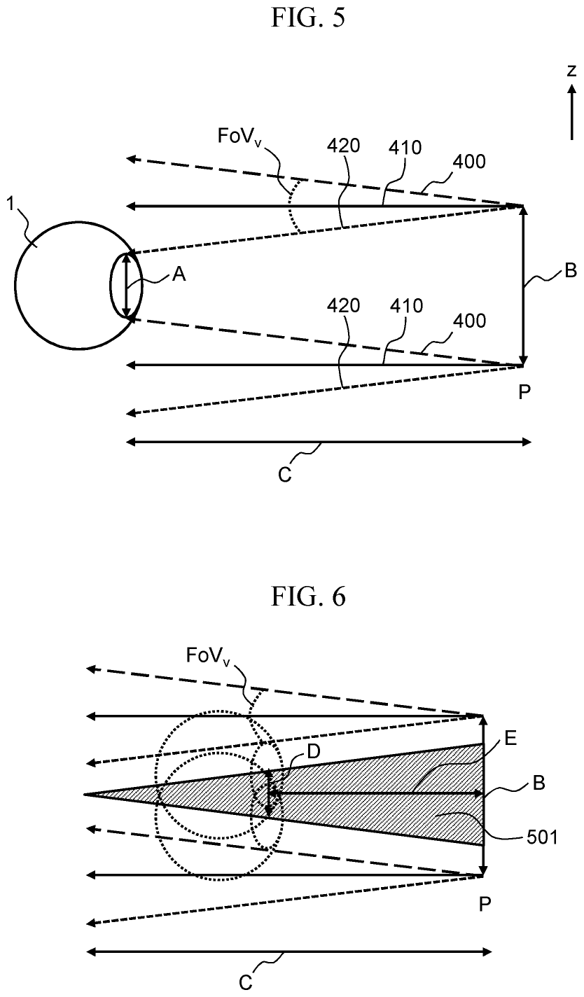

FIG. 5 is a schematic diagram illustrating a light beam from the pupil plane P to the user 1. This figure shows a trade-off relationship between FoV and eye-box. Assuming that the diameter of the eye (pupil) of the user is A, the beam diameter of the image light in the pupil plane P is B, and the distance from the eye of the user 1 to the pupil plane is C, the equation 1 below is derived. FoVv indicates FoV in the perpendicular direction (z direction).

$$\begin{matrix}Equation 1 & \\ {FoV}_{v} = 2 {tan}^{- 1} ( \frac{B - A}{2 C} ) & ( 1 )\end{matrix}$$

Equation 1 was derived under an assumption that the image is correctly visible when the light fills all the pupils of diameter A. The eye-box is a movable range of the eye in which the user can visually recognize the entire image light. Under the condition where this equation is satisfied, the eye-box is the narrowest, because not all of FoV of the image light can be visually recognized even when the eyes move up and down slightly. On the other hand, this condition maximizes the FoV. Then when the eye of the user 1 comes closer to the waveguide (pupil plane P), the eye-box expands as described below.

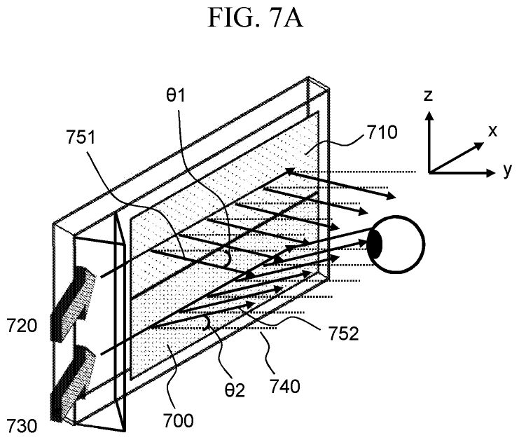

FIG. 6 illustrates a case where the user is at a position where the distance between the pupil plane P and the eye of the user 1 is E (E<C). In this case, the width D in the z direction of the eye-box is expressed by the equation 2 below.

$$\begin{matrix}Equation 2 & \\ D = ( B - A ) ( 1 - \frac{E}{C} ) & ( 2 )\end{matrix}$$

Removing C from Equations 1 and 2 leads to Equation 3 below. In Equation 3, a formula is used that tan θ≈θ when θ is sufficiently small.

$$\begin{matrix}Equation 3 & \\ {FoV}_{v} = 2 {tan}^{- 1} ( \frac{B - A - D}{2 E} ) \text{∼} \frac{B - A - D}{E} & ( 3 )\end{matrix}$$

From Equation 3, a trade-off between FoVv and eye-box D is identified. In other words, when attempting to realize a wide FoV in the non-waveguide direction, the waveguide of the one-dimensional expanding type cannot expand the eye-box in that direction.

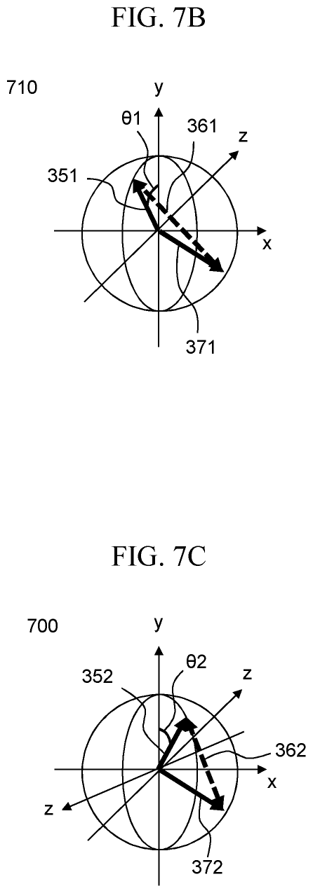

FIG. 7A illustrates a configuration of a waveguide according to the embodiment 1. The embodiment 1 has a configuration that overcomes the above-described trade-off relationship in the non-light-guiding direction. This configuration has two image light (upper image light 720 and lower image light 730). The emitting coupler unit is also spatially separated into two of the upper emitting coupler unit 710 and the lower emitting coupler unit 700. The lower emitting coupler unit 700 is an angle conversion unit having a characteristic of emitting incident light into the upper side (z axis positive direction). The upper emitting coupler unit 710 is an angle conversion unit having a characteristic of emitting incident light into the lower side (z axis negative direction). By inputting two image light different from each other and emitting each image light by the emitting coupler unit having different characteristics from each other, it is possible to enter the principal ray toward the eye of the user 1. Accordingly, the FoV of the non-waveguide direction (z direction) can be approximately doubled. In FIG. 7A: the angle between the support line 740 and the light beam 751 emitted from the upper emitting coupler 710 is θ1; the angle between the support line 740 and the light beam 752 emitted from the lower emitting coupler 700 is θ2.

In other words, the upper emitting coupler unit 710 and the lower emitting coupler unit 700 are disposed so as to face each other with respect to the center of the waveguide 200. The light beams 751 and 752 are emitted toward the direction approaching to each other with respect to the normal line extending from the center line of the waveguide 200 along the x direction.

FIG. 7B is a grating vector in the upper emitting coupler unit 710. FIG. 7C is a grating vector in the lower emitting coupler unit 700. These diagrams are made by redrawing FIG. 3B according to the configuration of FIG. 7A. In this configuration, the grating vectors 361 and 362 are configured so that the emitted light 351 and 352 have an inclination of θ1 and θ2, respectively, in the yz plane rather than parallel to the y-axis. This makes it possible to cause the principal ray (center beam) of the image light to proceed toward the eye of the user 1.

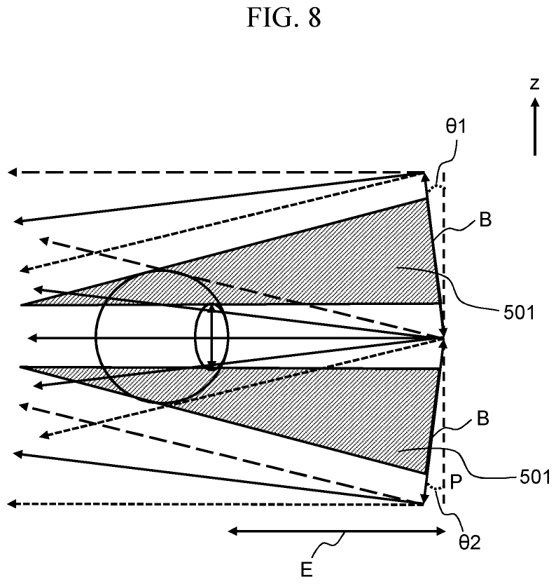

FIG. 8 is a conceptual diagram showing a configuration of the non-waveguide direction. FIG. 8 is made by redrawing FIGS. 5 and 6 according to the configuration of FIG. 7A. For the sake of simplicity, FIG. 8 shows a diagram in which the angle is converted in the pupil plane P. The inclination angles θ1 and θ2 of the emitted light from the y-axis matches with the angle formed by the xy cross section of the principal ray (central ray) and the z-axis. For example, when θ1=θ2=θ, by setting this angle as shown in Equation 4 below, FoV can be approximately doubled.

$$\begin{matrix}Equation 4 & \\ θ ≦ \frac{{FoV}_{v}}{2} = {tan}^{- 1} ( \frac{B - A - D}{2 E} ) & ( 4 )\end{matrix}$$

In Equation 4, parameters A, B, D, and E follow the definitions above. FoVv is the FoV of one projector. By combining two of upper and lower FoVv, it is possible to realize nearly twice of FoV. In the condition of the first equal sign in Equation 4, FoV is doubled. In the condition of the unequal sign in Equation 4, FoV is smaller than doubled. However, in the latter case, it is possible to form a portion where the upper and lower images overlap with each other, and it is possible to make the boundary of the image combination inconspicuous. With this approach, the eye-box of one projector has the aforementioned trade-off relation between FoVv, whereas the combination of two eye-boxes of each projector is not narrowed. Therefore, FoVv can be doubled without narrowing the eye-boxes of the upper and lower projectors.

### Embodiment 1: Summary

In the HMD 100 according to the embodiment 1, the waveguide 200 includes two angle converting unit (the upper emitting coupler unit 710 and the lower emitting coupler unit 700). Each of the angle converting units emits the image light in different directions from each other, respectively. As a result, it is possible to solve the two problems: (1) the light utilization efficiency is decreased in the waveguide direction, and (2) a trade-off relationship exists between the FoV and the eye-box in the non-waveguide direction. Therefore, it is possible to use the one-dimensional expansion method of high light utilization efficiency, as well as resolving the trade-off between the FoV in the non-guiding direction and the eye-box.

### Embodiment 2

In the embodiment 1, the eye-box for simultaneously viewing the entire FoV of the image of both the upper and lower projectors is limited to the center of the waveguide (the boundary portion between the upper emitting coupler unit and the lower emitting coupler unit) since the light beam at the angle of the innermost (center of the combined image) of both projectors is required to enter the eye (even in this case, light beam enters only half of the eye pupil). In an embodiment 2 of the present disclosure, a configuration example will be described in which this problem is improved.

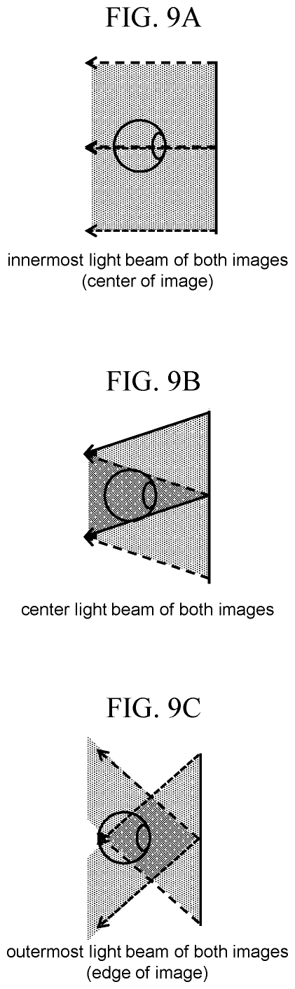

FIGS. 9A-9C illustrate light beams of different angles emitted from the projector (innermost, center, outermost). All of the central and outer beams of the projectors shown in FIGS. 9B and 9C can be seen. However, the innermost beam shown in FIG. 9A (the center of the visible image) enters only half of the pupil. In order to solve this problem, the following configuration is used in the embodiment 2.

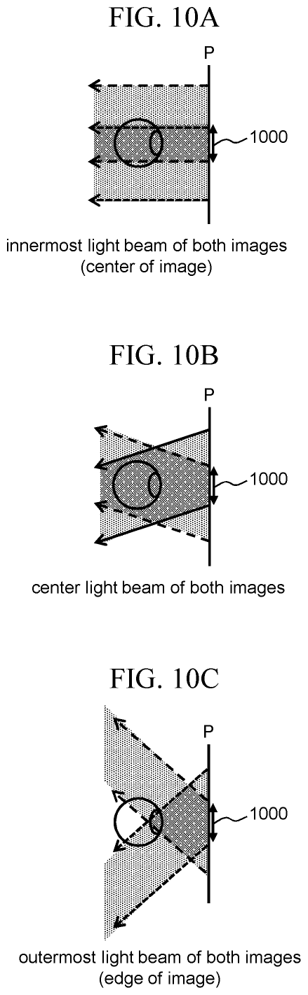

FIGS. 10A-10C are schematic diagrams illustrating configurations in which a region 1000 where the beam regions of the projector for projecting upper and lower images overlap with each other. By having the emitted beams overlap in the pupil plane P, the innermost beam can be made sufficiently incident on the user's pupil. Therefore, it is possible to expand the eye-box.

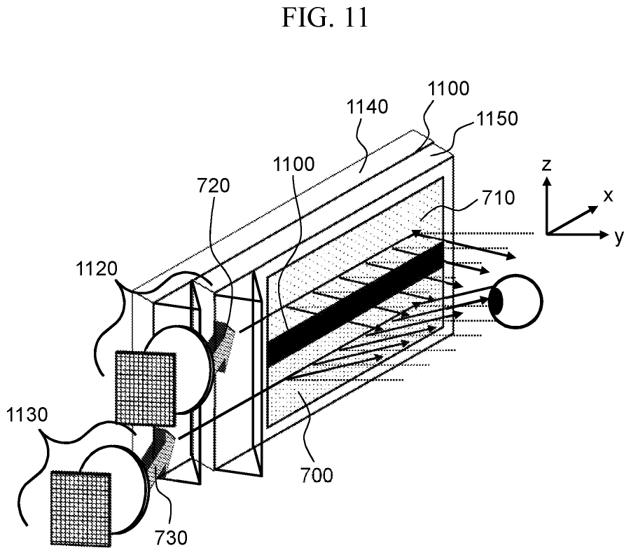

FIG. 11 illustrates a specific configuration of a waveguide that realizes superimposing emitted light beams as shown in FIG. 10A to FIG. 10C. The difference from FIG. 7A is: the waveguide has a two-layer structure in which the waveguides are divided into two layers; the upper emitting coupler unit 710 is included in the waveguide layer 1150 on the side closer to the user; the lower emitting coupler unit 700 is included in the waveguide layer 1140 on the rear side away from the user; there is an overlapping area 1100 in which these two emitting coupler units overlap when viewed from the user. Between the two waveguide layers, there is a layer (e.g. an air layer) having a refractive index different from that of the waveguide layers 1140 and 1150, so that light guided by total internal reflection of each layer does not enter the other layer except at the time of emission (cross talk between layers is suppressed). The two projectors (the upper image output unit 1120 and the lower image output unit 1130) are arranged on waveguides of different layers, respectively, so that the eye-box can be effectively expanded as in described above.

### Embodiment 3

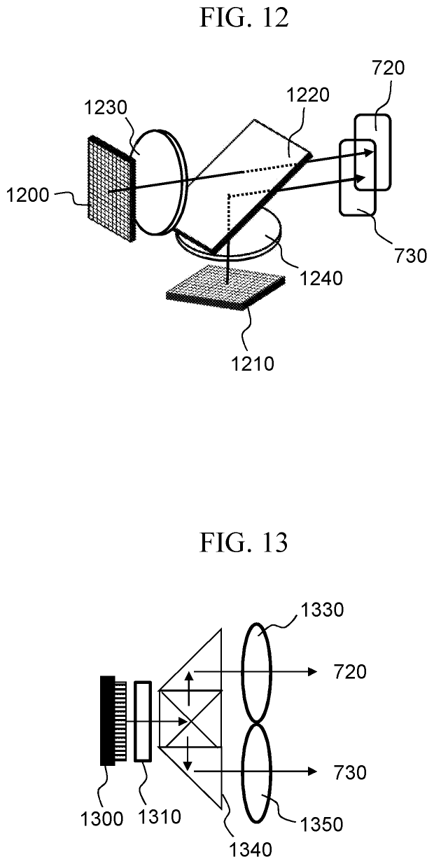

FIG. 12 illustrates a configuration example of the image outputting unit for generating upper image light 720 and lower image light 730. The panel 1200 and the panel 1210 are displays for generating the upper image light 720 and the lower image light 730, respectively. The panels 1200 and 1210 are configured by a combination of a two-dimensional spatial light modulator (DMD (Digital Mirror Device) or LCOS (Liquid Crystal On Silicon)) and a light source, or a self-emitting device such as a OLED (Organic Light Emitting Diode) or a micro-LED (Light Emitting Diode). By projecting the image generated by these displays to substantially infinity (Fourier transform) by the lens 1230 and 1210, it is possible to display a virtual image. These two image beams are light beams having a beam diameter of several millimeters. By using an optical coupling element 1220 such as a polarizing beam splitter, it is possible to output a beam having an overlap.

The two image light travel through optical paths that are not parallel to each other (orthogonal in FIG. 12) in the paths until they reach the optical coupling element 1220, and proceed approximately parallel to each other in the paths after the optical coupling element 1220. Therefore, the two image output units need not be arranged adjacent to each other in the same plane. Thus it is possible to reduce the plane size of the image output unit.

FIG. 13 illustrates another configuration example of the image outputting unit. In this configuration, using a high-speed polarization switching unit 1310 configured by of a liquid crystal device or the like, the image generated by the panel 1300 is displayed by time-division of two images. That is, an image A is displayed at one moment, and an image B is displayed at another moment, while the polarization direction of light is switched by 90 degrees in synchronization with the time-division display. This is switched alternately at 60 Hz or faster. This image is divided into two light beams spatially separated by a light beam divider 1340 configured by a polarizing beam splitter cross prism or the like. Then a virtual image is generated by the lenses 1330 and 1350, respectively. Accordingly, it is possible to generate the image by a single panel, thereby realizing low cost and miniaturization.

### <Modifications of the Present Disclosure>

The present disclosure is not limited to the above-described embodiments, and various modifications are included. For example, the above-described embodiments have been described in detail for the purpose of illustrating the present disclosure easily, and are not necessarily limited to those comprising all the described configurations. It is also possible to replace a part of the configuration of one embodiment with the configuration of another embodiment, and it is also possible to add the configuration of another embodiment to the configuration of one embodiment. Further, it is possible to add, delete, or replace a part of the configuration of each embodiment.

In the embodiment 2, the overlapping region 1100 extends from the left side to the right side of the waveguide 200. The overlapping region 1100 is not limited to this configuration. For example, the overlapping region 1100 may be disposed only in the vicinity of the center of the waveguide 200. Alternatively, the overlapping region 1100 may be disposed only in the vicinity of the left and right sides of the waveguide 200.

In the embodiments above, the waveguide 200 including two angle conversion units has been exemplified. However, three or more angle conversion units can also be provided. Regions in which the angle converting units overlap each other can be similarly formed at the boundary portions between the angle converting units.

In the embodiments above, the present disclosure is applied to HMD 100. However, the present disclosure can be applied to other image display devices. For example, in at least a part of a front glass of a vehicle, the effect of the present disclosure can be realized by arranging two or more angle conversion units in the waveguide in the same manner as the present disclosure.

### DESCRIPTION OF SYMBOLS

1: user
100: HMD (head mounted display)
200: waveguide
104: image display unit
101: image inputting unit
102: image quality corrector
103: image projector
201: incident coupler
200: waveguide
201: incident coupler
202: eye-box expander
203: emitting coupler
700: lower emitting coupler unit
710: upper emitting coupler unit

What is claimed is:

1. An image display device for projecting image light as a virtual image, comprising:
an image light projector that emits the image light; and
a waveguide that propagates the image light,
wherein the image light projector emits, as the image light, first image light and second image light,
wherein the waveguide comprises:
a propagator that propagates the first image light and the second image light in a first direction;
a first angle converter that emits the first image light in a second direction which is not parallel to the first direction; and
a second angle converter that emits the second image light in a third direction which is not parallel to the first direction and is different from the second direction.

2. The image display device according to 1,
wherein the first angle converter is placed in a first region of the waveguide extending along the first direction, and
wherein the second angle converter is placed in a second region of the waveguide extending along the first direction and different from the first region.

3. The image display device according to claim 2,
wherein the first angle converter and the second angle converter are placed at positions facing each other with respect to a center of the waveguide,
wherein the first angle converter emits the first image light in a direction approaching a normal line extending from a center line of the waveguide along the first direction, thereby emitting the first image light in the second direction, and
wherein the second angle converter emits the second image light in a direction approaching a normal line extending from the center line, thereby emitting the second image light in the third direction.

4. The image display device according to claim 3, wherein
when a half of an angular difference between the second direction and the third direction is defined as θ, and when a viewing angle in a plane including the second direction and the third direction is FOV,
θ≤(FOV/2) is satisfied.

5. The image display device according to claim 2,
wherein the first angle converter and the second angle converter are placed at positions where a first projection region in which the first angle converter is projected onto the waveguide and a second projection region in which the second angle converter is projected onto the waveguide overlap with each other.

6. The image display device according to claim 5,
wherein the first angle converter and the second angle converter are arranged such that an overlapping region in which the first projection region and the second projection region overlap with each other extends along the first direction.

7. The image display device according to claim 5,
wherein the waveguide comprises:
a first layer that includes the first angle converter and propagates the first image light;
a second layer that includes the second angle converter and propagates the second image light; and
a third layer that has a third refractive index different from both a first refractive index of the first layer and a second refractive index of the second layer,
wherein the third layer is placed between the first layer and the second layer.

8. The image display device according to claim 1,
wherein the image light projector comprises:
a first generator that generates the first image light;
a second generator that generates the second image light; and
an optical element that transmits the first image light and reflects the second image light while,
wherein the first generator and the second generator are arranged so that the first image light and the second image light propagate in a direction not parallel to each other in an optical path until the first image light and the second image light reach the optical element.

9. The image display device according to claim 1,
wherein the image light projector emits the first image light and the second image light according to a time division scheme.

10. The image display device according to claim 1,
wherein the image display device is configured as a head mounted display that can be worn on a head of a user.

11. The image display device according to claim 1,
wherein the image display device is configured to display an image on at least a portion of a front glass of a vehicle.
